(19) United States
(12) Patent Application Publication
(10) Pub. No.: US 2009/0175691 A1
(43) Pub. Date: Jul. 9, 2009

(54) PNEUMATIC CONVEYOR FOR BOTTLES

(76) Inventor: Herwig Hirschek, Bobingen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/304,796

(22) PCT Filed: Jun. 18, 2007
(86) PCT No.: PCT/EP2007/005351

§ 371 Date: Dec. 15, 2008

(30) Foreign Application Priority Data
Jun. 19, 2006 (DE) 20 2006 009 652.3

(51) Int. Cl. B65G 51/03

(52) U.S. Cl. 406/88

(57) ABSTRACT

The invention relates to an air conveyor (2) for bottles (3), comprising at least one guide channel (16) in which the bottles (3) are guided in a suspended manner. Said air conveyor (2) comprises at least one converter (7) provided with at least one displaceable guide channel section (17), a lifting device (20) and an unloading device (21). The air channel (15) of the air conveyor (2) is arranged perpendicular to the direction of transport and the displaceable guide channel (17).

### CROSS REFERENCE TO RELATED APPLICATIONS

This application is a United States National Phase application of International Application PCT/EP2007/005351 and claims the benefit of priority under 35 U.S.C. § 119 of German Patent Application DE 20 2006 009 652.3 filed Jun. 19, 2006, the entire contents of which are incorporated herein by reference.

### FIELD OF THE INVENTION

The present invention pertains to a pneumatic conveyor for bottles with at least one guide channel and at least one transfer unit. The transfer unit has at least one mobile guide channel section, a lifting means and an unloading means.

### BACKGROUND OF THE INVENTION

Such pneumatic conveyors are known from practice. They have one or more guide channels, in which the bottles are guided suspended and are driven forward by an airflow. The airflow is branched off, e.g., from an air duct located above or laterally from the guide channel via flow connections and fed into the guide channel. For removal, the bottles are transferred at the end of the pneumatic conveyor onto a running conveyor belt or another conveyor, which extends along the end of the pneumatic conveyor and takes over the bottles blown off.

### SUMMARY OF THE INVENTION

An object of the present invention is to show a better pneumatic conveyor.

The present invention accomplishes this object with a pneumatic conveyor that has at least one transfer unit.

The transfer unit makes it possible to introduce and remove the bottles not only at the end of the pneumatic conveyor, but also at any desired point within the pneumatic conveyor line. This introduction and removal can take place very rapidly and within the cycle times preset in the unit. The air duct can extend without interruption over the transfer or introduction/removal site.

A buffer station can be formed with this transfer unit, which makes it possible to remove and temporarily store the bottles in case of disturbances in the line or disturbances occurring for other reasons, and these bottles can again be rapidly reintroduced into the pneumatic conveyor and conveyed farther after elimination of the disturbance. This buffer station makes it possible to substantially shorten the pneumatic conveyor compared to prior-art constructions, in which buffering was created over long, meandering conveying paths.

The transfer unit can also be used in another way, e.g., as a removal and loading station for a palletizing unit. The bottles can be placed row by row on a tray, which is fed via one or more conveyors to a bottle pick-up and can be displaced laterally for filling row by row. The tray can be used for the storage function or for the palletizing function. In the simplest case, an intermediate layer can be provided as the tray for a palletizing unit with temporary guides for the deposited rows of bottles.

The transfer unit or the buffer station may be integrated in new units. As an alternative, existing units and pneumatic conveyors can be retrofitted with them. In addition, improved and more uniform bottle conveying is possible with the means being claimed in the pneumatic conveyor line.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a cut-away front view of a pneumatic conveyor with a transfer unit and a buffer station;

FIG. 2 is a side view of the device according to FIG. 1; and

FIG. 3 is a schematic top view of a bottle handling unit with a pneumatic conveyor.

### DESCRIPTION OF THE PREFERRED EMBODIMENTS

Referring to the drawings in particular, the present invention pertains to a pneumatic conveyor (2) for bottles (3), especially plastic bottles. The pneumatic conveyor (2) is provided with a transfer unit (7), which may be part of a buffer station (12). The present invention pertains, furthermore, to a bottle handling unit (1) with such a pneumatic conveyor (2) with transfer unit (7) and buffer station (12).

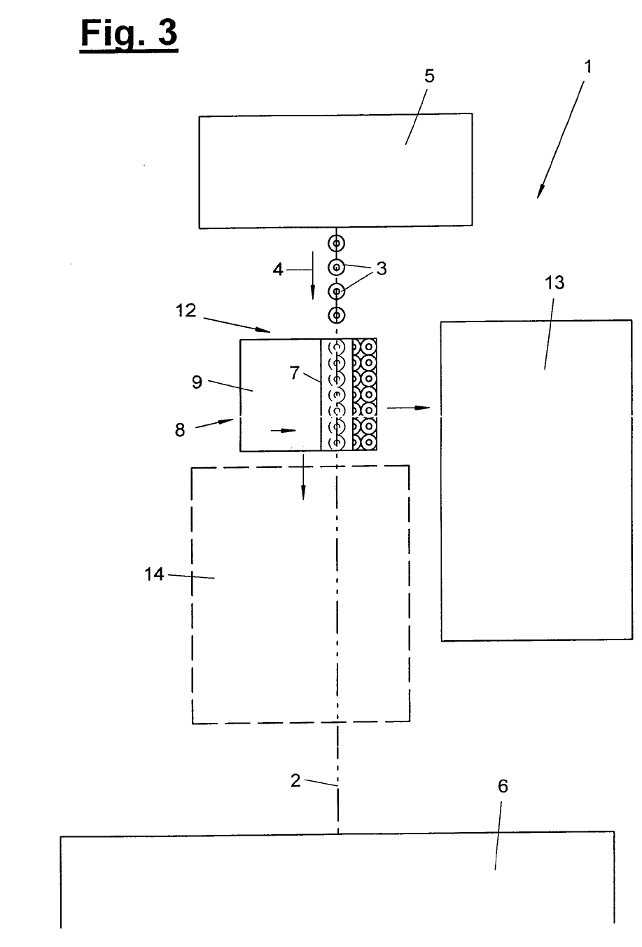

FIG. 3 schematically shows a bottle handling unit (1). It comprises an input-side bottle producer (5), which may be designed, e.g., as a blowing machine for plastic bottles. As an alternative, the bottle producer (5) may be an unpacker or another device. A pneumatic conveyor (2), which is schematically indicated as a pneumatic conveying line in FIG. 3, is connected to the bottle producer (5). The pneumatic conveyor (2) connects the bottle producer (5) to a filling unit (6). A pneumatic conveyor (2) of the type shown and described may also be arranged in other locations of the bottle handling unit (1), e.g., between the filling unit (6) and a downstream labeling station as well as a palletizing unit or the like. The bottles (3) are transferred from the bottle producer (5) one by one to the bottle conveyor (2) and conveyed there one by one or in groups in a suitable manner, e.g., suspended by the neck (19) of the bottle.

To introduce and remove the bottles (3), the pneumatic conveyor (2) has a transfer unit (7). The transfer unit (7) may form, besides, a buffer station (12), which makes possible the temporary storage of the removed bottles and the reintroduction of the bottles (3) into the pneumatic conveyor (2). The transfer unit (7) has a mobile bottle pick-up (8) for the removed bottles (3). The removed bottles (3) can now be deposited on a tray (9) row by row. To assume the buffering function, a plurality of trays (9) may be present and filled one after another. The filled trays (9) may be stacked up here in layers by means of a tray stacker in a space-saving manner to form a tray stack and again removed from the stack as needed. As an alternative, they can be conveyed into an adjacent tray storage unit (13) and stored in shelf guides or the like there.

The bottles (3) being delivered continuously from the bottle producer (5) can be buffered and stored temporarily with the buffer station (12) if a disturbance occurs in the further course of the pneumatic conveyor line, e.g., in the area of the filling unit (6). When the disturbance has been eliminated, the bottles (3) can again be introduced into the pneumatic conveyor (2) with the transfer unit (7). In addition, bottles (3) can be kept ready in the buffer station (2) or in the tray storage unit (13) for the case of other disturbances when, e.g., there is a failure in the bottle producer (5) and bottle production is interrupted. To maintain the operation of the filling unit (6), the bottles (3) being stored as a precaution can be introduced in this case from the buffer station (12) into the pneumatic conveyor (2).

FIG. 3 shows another functional variant with a palletizing unit (14) drawn by broken line. The bottles (3) can be removed with the transfer unit (7) and palletized immediately. The bottles (3) being removed row by row are deposited for this on a tray (9), which is designed, e.g., as a temporary storage unit and which is conveyed after filling into the palletizing unit (14) and is palletized there. The transfer unit (7) may also be an integral part of the palletizing unit (14).

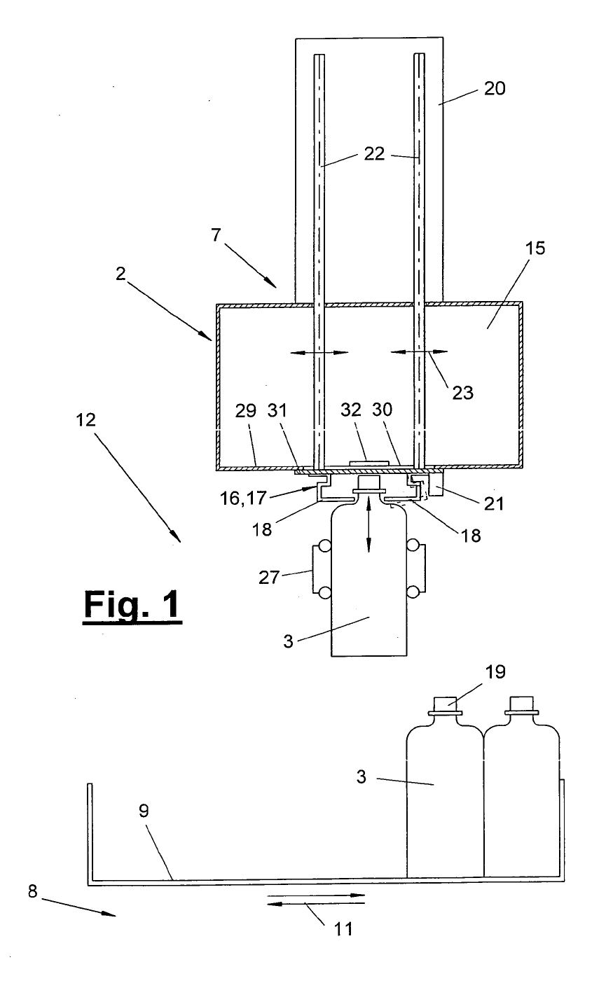

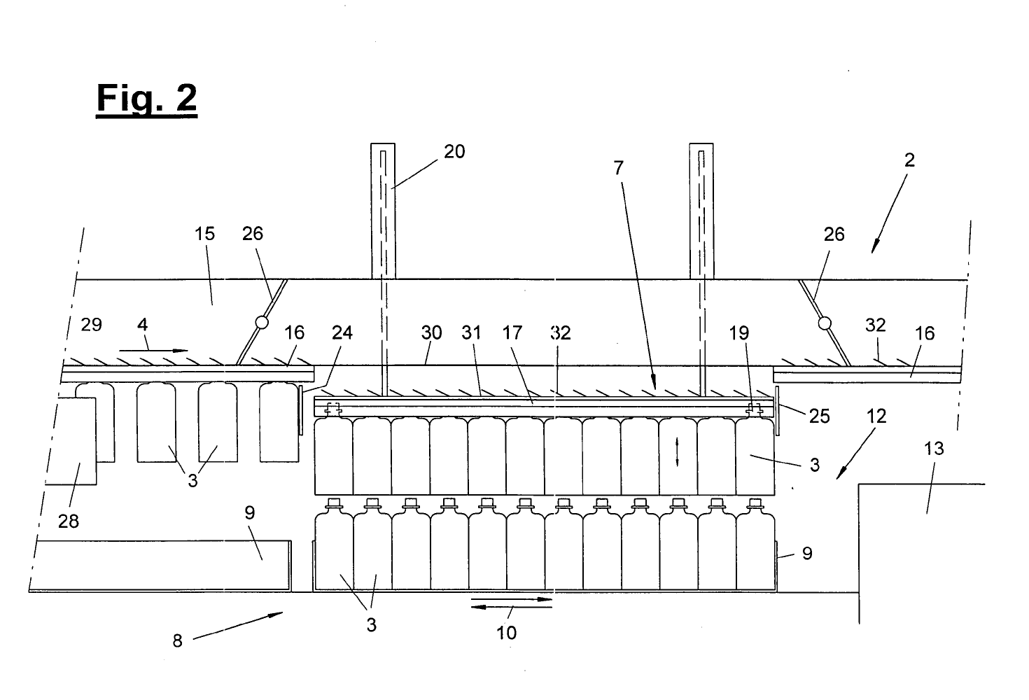

FIGS. 1 and 2 show specifically the pneumatic conveyor (2) and the transfer unit (7). The pneumatic conveyor (2) has one or more guide channels (16), in which the bottles (3) are conveyed suspended by a broadened collar of the bottle neck (19). The guide channel (16) comprises, e.g., two rail-like and bent guide strips (18), which form the channel space and leave open a slot for the passage of the bottle neck (19) between their lower legs. The conveying air is fed into the guide channel (16) from an air duct (15) located above or laterally next to same by a permanent airflow being generated in the direction of conveying by means of one or more blowers, not shown. The air vibration is introduced via flow connections (32) at the bottom (29) of the air duct (15) into the guide channel (16) located under it. The air connections (32) may comprise a series of openings in the bottom with scale-like baffle plates arranged above them. The airflow introduced obliquely through the flow connection (32) drives the bottles (3) forwards when reaching the bottle neck and the mouth opening of said neck.

The transfer unit (7) is used to introduce and remove the bottles (3). In the embodiment being shown, it is integrated in the pneumatic conveyor (2) and may be located at any desired site in the pneumatic conveyor line. As an alternative to the exemplary embodiment being shown, the transfer unit (7) may also be located at the end of the pneumatic conveyor (2).

The transfer unit (7) has at least one mobile guide channel section (17), a lifting means (20) and an unloading means (21). The guide channel section (17) is a separate component of the guide channel (16) and can be raised and lowered by means of the lifting means (20). The bottles (3) located in the guide channel section (17) can now be moved along as well. The air duct (15) is preferably not interrupted in the area of the transfer unit (7) and extends over the transfer site. The air duct (15) and the mobile guide channel section (17) extend next to each other at right angles to the direction of conveying, e.g., laterally next to each other or one under the other.

The bottles (3) can be released from the guide channel section (17) and placed on a mobile bottle pick-up (8) by means of the unloading means (21). As an alternative, bottles (3) kept ready at the bottle pick-up (8) can be grasped for introduction. The guide channel section (17) has mobile guide strips (18) for this purpose for the bottle neck (19), which can be opened and closed with the unloading means (17) by a pivoting motion or lateral travel motion. In the opened position they release the bottle neck (19). They grasp under the collar on the bottle neck (19) in the closed position.

In the area of the transfer unit (7), the air duct (15) has a bottom opening (30), in or at which a bottom plate (31) with the guide channel section (17) is arranged and can be raised and lowered with this by means of the lifting means (20). FIG. 1 shows the raised position, in which the bottom plate (31) tightly closes the bottom opening (30). The bottom plate (31) may have the same function as the bottom (29) and be equipped with a plurality of flow connections (32). The guide channel section (17) is aligned with the other stationary parts of the guide channel (16) in the raised position and forms an integral part of the pneumatic conveyor (2) together with the bottom plate (31).

The lifting means (20) and the unloading means (21) are schematically indicated in FIGS. 1 and 2. The lifting means (20) is attached, e.g., to the pneumatic conveyor (2), especially to the air duct (15), and has one or more lifting elements (22), which pass through the air duct (15) and are connected to the bottom plate (31) or possibly also to the guide strips (18). The lifting elements, which are, e.g., of a rod-like design, may be provided, furthermore, with an adjusting means (23), with which they can be moved at right angles to the axis of the channel and their distance can be changed. If a guide strip (18) each is connected to the end of the lifting rod, the format and especially the width of the guide channel section (17) can be changed by means of the adjusting means (23) for adaptation to different bottle sizes. The stationary guide channels (16) may be correspondingly adjustable. The adjusting means (23) may assume, moreover, the function of the unloading means (21) by the bottle neck (19) being able to be released or picked up due to the lifting rods (22) and the guide strips (18) moving apart. A separate unloading means (21) may be eliminated in this case.

As an alternative, the unloading means (21) may be arranged in the area of the bottom plate (31) and move one or both guide strips (18) for opening and closing the guide channel section (17), in which case it performs, e.g., a pivoting motion and/or a lateral shifting motion. The unloading means may have any desired design and arrangement. It is indicated schematically in FIG. 1. It may comprise, e.g., a pivoting mechanism at the end of the guide strips (22) with which the guide strips (16) can be pivoted so as to perform an opening or closing motion. The pivoting mechanism may be stop-controlled or position-controlled and perform the opening and closing motion in the lowered position of the transfer unit (7).

The pneumatic conveyor (2) may have one or more bottle stoppers (24, 25) in the area of the transfer unit (17). Furthermore, the pneumatic conveyor (2) may have a seal (26) for interrupting the airflow at a suitable location in the flow guide, e.g., in the air duct (15). A bottle stopper (24, 25) each is arranged in front of and behind the vertically movable guide channel section (17) in the embodiment being shown. The front bottle stopper (25) is used to form a tight row of bottles (3) in the guide channel section (17), which has a coordinated length for this. The bottles are introduced and removed row by row with the transfer unit (7). The rear bottle stopper (24) is used to stop the bottles (3) arriving in the direction of conveying (4) at the pneumatic conveyor (2). The bottles stoppers (24, 25) are controllable and have a suitable actuating drive. The seal (26) may have any desired design. It comprises, e.g., a rotatable flap arranged in front of the transfer unit (7). In addition, another seal (27) may be arranged behind the transfer unit (7).

A separating means (28), which comprises, e.g., a worm, a star wheel or the like, may be arranged at the pneumatic conveyor (2) in front of the transfer unit (7) in the direction of conveying (4). The separating means (28) is used to form a defined row of bottles in the guide channel (16) in front of the transfer unit (7). Furthermore, the arriving bottles (3) can be straightened up and counted with the separating means (28). The transfer unit (7) can be controlled via a suitable control depending on the result of counting.

The bottle pick-up (8) is used to pick up the row of bottles during removal and introduction. It comprises, e.g., a table-like frame for receiving at least one tray (9). The bottle pick-up (8) has two conveyors (10, 11), which are directed at right angles to one another and which act on the tray (9). Trays (9) can be brought on and removed with one conveyor (10), which is directed, e.g., along the direction of conveying (4). The tray (9) can be offset laterally in steps corresponding to the width of the bottle with the conveyor (11) directed at right angles to the direction of conveying (4) in order to make it possible to insert or remove the rows of bottles one after another.

The tray (9) may have any desired shape. In the embodiment being shown, it has a tub shape with a bottom and circumferential side walls. The tray may have longitudinally and/or transversely extending guide strips on the inner side for separating and positioning the individual bottles (3). The tray (9) may be able to be stacked with or without bottles (3) and have a corresponding design of the side walls and of the bottom area for this.

The transfer unit (7) may have, furthermore, the bottle guide (27), which is indicated schematically in FIG. 1 and which comprises, e.g., a railing, which is located at the bottom plate (31) and whose width and/or height are possibly adjustable and with which the row (3) of bottles grasped by the transfer unit is guided laterally. As an alternative, the bottle guide (27) may be arranged stationary and mounted at the bottom (29) of the air cooling channel (15). Furthermore, the bottle guide (27) may have additional guide elements on the front and the rear side of the row of bottles picked up in order to offer an all-round guiding for the row of bottles during raising and lowering.

FIGS. 1 and 2 illustrate different steps of the introduction and removal operation. In FIG. 1, the guide channel section (17) and the bottom plate (31) are in the raised position and close to the underside of the air duct (15). When the bottle stoppers (24, 25) are in the inoperative position, the bottles (3) can be conveyed through the transfer unit (7) and the guide channel section (17). When a row of bottles is to be removed, the front bottle stopper (25) at first withdraws, as a result of which the arriving bottles (3) form the row shown in FIG. 2. When the row is complete, the rear bottle stopper (24) withdraws and stops the next bottles in the pneumatic conveyor (2). The lifting means (20) is activated and lowers the guide channel section (17) in the manner shown in FIG. 2 with the row of bottles picked up onto the bottle pick-up (8) and places them on the tray (9). By actuating the unloading means (21), the deposited row of bottles is released and the guide channel section (17) with the bottom plate (31) is again moved upward into the position shown in FIG. 1. After retracting the bottle stopper (24), the bottles piled up can be blown into the guide channel section (17). The tray (9) is meanwhile shifted laterally by the width of one bottle by the conveyor (11) in order to be able to pick up the next row of bottles.

When bottles (3) are introduced from the buffer station (12) or from the tray storage unit (13), the above-described operation takes place in the reversed order. The bottles (3) arriving on the pneumatic conveyor (2) are stopped by the rear bottle stopper (24) and possibly piled up. By actuating the unloading means (21), one row of bottles can be grasped with the lowered guide channel section (17) from the bottle pick-up (8) or from the tray (9) and raised. The guide channel section (17) is aligned with the further course of the guide channel (16) in the raised position, so that the row of bottles can be grasped by the conveying airflow and removed in the direction of conveying (4) in the pneumatic conveyor (2). During introduction, the bottle stopper (25) can likewise come into action and control the point in time for releasing and further conveying the introduced row of bottles. The other bottle stopper (24) can likewise open after the introduction. The conveyor (11) cyclically moves the tray (9) farther by one row of bottles, so that the introduction operation can take place anew. When there is a disturbance on the feed side, the bottle stopper (24) does not need to come into action.

When a tray (9) is filled during the removal of bottles (3), it can be conveyed from the bottle pick-up (8) with the conveyor (10) to an adjacent tray stacker and/or to the tray storage unit (13). A filled tray (9) is conveyed from the tray stacker or from the tray storage unit (13) to the bottle pick-up (8) and made ready during removal.

The tray (9) may be designed in the above-mentioned manner without side walls and as a simple bottom plate, e.g., as an intermediate layer for a pallet stacker. The position of the bottles (9) standing on the tray can be secured in this case by lateral pushers or other guide elements, which are provided with a controllable feed drive and which are possibly also moved along by a certain amount during rotary transportation in the palletizing unit (14). The guide elements may form a guide frame with one another. Such guide elements may also be used in connection with the tub-like trays shown in the exemplary embodiments and used to secure the row of bottles standing freely on one side.

Various modifications of the embodiments shown and described are possible. On the one hand, the bottom (29) of the air duct (15) may be closed with the exception of the passage openings for the lifting rods (22), in which case the lifting rods (22) passing through are directly connected to the guide strips (18). The mobile bottom plate (31) and the bottom opening (30) may be eliminated in this design. Only the guide channel section (17) is raised and lowered in this case. Furthermore, the lifting means (20) may have a different design. It does not have to have the channel attachment with the drive and the guide for the lifting rods (22) passing through the air duct (15). The lifting means (20) may also be arranged under or laterally next to the air duct (15) or optionally at a frame independently from the air duct (15) and act on the guide channel section (17) from the side.

Furthermore, it is possible to arrange at an air duct (15) a plurality of guide channels (16) and correspondingly a plurality of guide channel sections (17) next to each other. A plurality of parallel rows of bottles can be grasped and introduced and removed together. The possibly existing distance between rows can be eliminated at the bottle pick-up (8) by the pushers or the like during the removal and established during introduction.

Furthermore, it is possible to replace the conveyor (11) for the lateral shifting of the trays with the above-mentioned pusher, in which case the rows of bottles are always made available on the tray (9) at the same point during the introduction and removal and are laterally displaced with the pusher subsequently or before. In another variant, the lifting means (20) may have an additional axis to laterally shift the picked-up row of bottles. The monoaxial lifting means shown performs only a lifting and lowering motion. The separation of the lifting means (20) and the transverse adjustment by the conveyor (11) or pusher has the advantage of an overlap in time of the motions and leads to time savings, which ensures a high velocity of introduction and removal. The cycle time is determined now essentially by the time needed during raising and lowering.

Furthermore, variations of the pneumatic conveyor (2) are possible. The conveying air may be fed to the guide channel (16) in a different manner. Furthermore, the guide channel (16) may be of a different design, which correspondingly applies to the guide channel section (17) and the guide strips (18) thereof.

While specific embodiments of the invention have been shown and described in detail to illustrate the application of the principles of the invention, it will be understood that the invention may be embodied otherwise without departing from such principles.

1. A pneumatic conveyor for bottles, comprising:
a guide channel, said guide channel guiding the bottles along a conveying path
a transfer unit with at least one mobile guide channel section, lifting means and an unloading means.

2. A pneumatic conveyor in accordance with claim 1, further comprising an air duct, said air duct extending perpendicular to a direction of conveying, said air duct being adjacent to said mobile guide channel section.

3. A pneumatic conveyor in accordance with claim 1, wherein said transfer unit has a mobile bottle pick-up for a plurality of rows of bottles, said mobile bottle pick-up being located at a position below said guide channel section.

4. A pneumatic conveyor in accordance with claim 1, wherein said guide channel section has mobile guide strips for engaging at least one bottle neck of one of the bottles.

5. A pneumatic conveyor in accordance with claim 4, wherein said transfer unit has an adjusting means for adjusting the guide strips.

6. A pneumatic conveyor in accordance with claim 1, further comprising a structure defining an air duct, said guide channel being arranged at an underside surface of said structure, wherein said structure has a bottom opening in an area of said transfer unit, said guide channel and a bottom plate being arranged in or at said bottom opening.

7. A pneumatic conveyor in accordance with claim 1, wherein said transfer unit has a plurality of bottle stoppers.

8. A pneumatic conveyor in accordance with claim 1, wherein said transfer unit has a bottle guide.

9. A pneumatic conveyor in accordance with claim 6, wherein said transfer unit has one or more switchable seals for adjusting a flow of air in said air duct.

10. A pneumatic conveyor in accordance with one claim 3, wherein said bottle pick-up has at least one conveyor for a tray.

11. A pneumatic conveyor in accordance with claim 1, further comprising a separating means for arranging the bottles in front of or at said transfer unit.

12. A pneumatic conveyor in accordance with claim 1, wherein said transfer unit is integrated within said guide channel.

13. A pneumatic conveyor in accordance with claim 1, wherein said transfer unit is connected to one or more of a tray storage unit and a palletizing unit.

14. A pneumatic conveyor in accordance with claim 1, said guide channel is connected on an input side to a bottle producer, said bottle producer being a blowing machine for plastic bottles.

15. A pneumatic conveyor in accordance with claim 1, wherein said guide channel is connected on an output side to a filling unit.

16. A bottle handling unit, comprising
a bottle producer, said bottle producer being a blowing machine for plastic bottles;
a filling unit;
a pneumatic conveyor including a buffer station with a transfer unit for introducing and removing the bottles, said buffer station with said transfer unit being arranged in said pneumatic conveyor between said bottle producer and said filling unit.

17. A bottle handling unit in accordance with claim 16, wherein said transfer unit has at least one mobile guide channel section, a lifting means and an unloading means, said pneumatic conveyor comprising an air duct extending along a length thereof and guide strips, said transfer unit having mobile guide strips for engaging at least one bottle neck of one of the bottles, said guide strips defining a guide channel means for receiving the bottles and guiding the bottles along a conveying path.

18. A pneumatic conveyor for bottles, comprising:
a plurality of guide strips defining a guide strip structure; and
a transfer unit comprising a movable guide section and a lifting means for moving said movable guide section from a first position to a second position, said movable guide section including a movable gripping means for gripping the bottles, said guide strip structure and said movable guide section defining a bottle conveying path when said movable guide section is in said first position, said movable guide section being located at a spaced location from said guide strip structure when said movable guide section is in said second position.

19. A pneumatic conveyor in accordance with claim 18, further comprising a wall structure defining an air duct, said wall structure including a bottom surface, said guide strip structure being arranged on said bottom surface, said guide strip structure being in communication with said air duct, said movable guide section being in communication with said air duct when said movable guide section is in said first position, said air duct receiving a flow of air, said guide strip structure and said movable guide section receiving said flow of air when said movable guide section is in said first position such that the bottles are conveyed along said conveying path via said flow of air.

20. A pneumatic conveyor in accordance with claim 18, further comprising:
a first bottle stopper located adjacent to one end of said transfer unit;
a second bottle stopper located adjacent to another end of said transfer unit;
a tray; and
a movable bottle pick-up element, said tray being arranged on said movable bottle pick-up element, said first bottle stopper and said second bottle stopper being mounted for movement such that said first bottle stopper and said second bottle stopper are movable from an inactive position to an active position, said first bottle stopper and said second bottle stopper defining a group of bottles when said first bottle stopper and said bottle stopper are in said active position and said movable guide section is in said first position, said movable guide section transferring said group of bottles to said tray on said movable bottle pick-up element when said movable guide section is in said second position, said first bottle stopper and said second bottle stopper being in said inactive position when the bottles are conveyed along said bottle conveying path.
